(19) United States
(12) Patent Application Publication
(10) Pub. No.: US 2025/0245434 A1
(43) Pub. Date: Jul. 31, 2025

(54) MONITORING AND DETECTION IN RESPONSE TO A PUBLIC SAFETY ALERT

(71) Applicant: International Business Machines Corporation, Armonk, NY (US)

(72) Inventors: NEIL DELIMA, Scarborough (CA); William Anderson, Cary, NC (US); Abdulhamid Adebowale Adebayo, White Plains, NY (US); Robert Filepp, Westport, CT (US); Andrew John Anderson, Stamford, CT (US)

(73) Assignee: International Business Machines Corporation, Armonk, NY (US)

(21) Appl. No.: 18/425,057

(22) Filed: Jan. 29, 2024

(51) Int. Cl. G06F 40/295; G06F 40/40

(52) U.S. Cl. CPC G06F 40/295; G06F 40/40

(57) ABSTRACT

An embodiment extracts, using a natural language processing model, a first entity from a public safety alert. An embodiment generates, using the first entity, a monitoring rule, the monitoring rule comprising an instruction to a sensor to collect sensor data. An embodiment detects, using a sensor data analysis model, a presence of the first entity within sensor data collected according to the monitoring rule.

### BACKGROUND

The present invention relates generally to public safety alert response. More particularly, the present invention relates to a method, system, and computer program for monitoring and detection in response to a public safety alert.

A public safety alert is a message, usually in text, video, or audio form, or a combination, alerting members of the public to a situation of which those alerted should be aware. For example, public safety alerts are used to warn the public of tornadoes, severe thunderstorms, blizzards, earthquakes, tsunamis, and other severe weather events, and to ask the public to watch for a kidnapped child, a missing senior citizen, or a fleeing suspect considered dangerous. For example, one public safety alert might be, “9:00 PM: The National Weather Service has issued a tornado warning for the following counties until 10:00 PM”, followed by a list of counties or other locations and additional information about the tornado's direction and speed of movement. Another example public safety alert might be, “7:00 PM: Kidnapped child alert, last seen in blue sedan, license plate number 123456, if seen please call police.” Public safety alerts are typically broadcast to those in an affected region via existing telecommunication and media networks or displayed on electronically controlled roadside signs, so that alerts are displayed on a user's mobile device, broadcast over local radio or television channels, delivered via text or voice message, injected into a cable television signal, displayed where visible to a camera (e.g., on a vehicle or a mobile device), or delivered via another means.

### SUMMARY

The illustrative embodiments provide for monitoring and detection in response to a public safety alert. An embodiment includes extracting, using a natural language processing model, a first entity from a public safety alert. An embodiment includes generating, using the first entity, a monitoring rule, the monitoring rule comprising an instruction to a sensor to collect sensor data. An embodiment includes detecting, using a sensor data analysis model, a presence of the first entity within sensor data collected according to the monitoring rule. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a flowchart of an example process for loading of process software in accordance with an illustrative embodiment;

FIG. 3 depicts a block diagram of an example configuration for monitoring and detection in response to a public safety alert in accordance with an illustrative embodiment;

FIG. 4 depicts an example of monitoring and detection in response to a public safety alert in accordance with an illustrative embodiment;

FIG. 5 depicts a continued example of monitoring and detection in response to a public safety alert in accordance with an illustrative embodiment; and

FIG. 6 depicts a flowchart of an example process for monitoring and detection in response to a public safety alert in accordance with an illustrative embodiment.

### DETAILED DESCRIPTION

The illustrative embodiments recognize that, once a public safety alert reaches the public, the onus is still on individuals to monitor their surroundings and respond to the alert. However, many people ignore alerts, particularly when not in a position to perform a task requested in an alert (e.g., an alert requesting watching for a kidnapped child when an alert recipient is home sleeping), an alert is not considered relevant (e.g., an alert requesting watching for a kidnapped child alert when an alert recipient is home watching a movie), or forget the details of an alert when they are in a position to perform a task requested in an alert (e.g., by the next morning when an alert recipient is driving and could be looking for a particular car or person). Thus, the illustrative embodiments recognize that there is an unmet need to supplement the public's response to a public safety alert using sensor data, particularly when an alert requests monitoring and reporting of a condition in a timely manner.

The present disclosure addresses the deficiencies described above by providing a process (as well as a system, method, machine-readable medium, etc.) that extracts, using a natural language processing model, a first entity from a public safety alert; generates, using the first entity, a monitoring rule comprising an instruction to a sensor to collect sensor data; and detects, using a sensor data analysis model, a presence of the first entity within sensor data collected according to the monitoring rule. Thus, the illustrative embodiments provide monitoring and detection in response to a public safety alert.

An illustrative embodiment receives a public safety alert. One embodiment receives a public safety alert in text form. Another embodiment receives a public safety alert in a non-textual form (e.g., audio, still image, or video), or a combination of a non-textual form and text, and uses a presently available technique to convert a non-text portion of the alert into text form for further analysis. For example, techniques are presently available to convert spoken audio to text, to extract text from video or a still image, and to generate text describing a portion of video or a still image.

An illustrative embodiment uses a presently available natural language processing model to extract one or more entities from the text form of a public safety alert. Some examples of presently available natural language processing models are implemented using the Natural Language Toolkit (NLTK) or Spacy libraries, both implemented in the Python computer language. (Spacy is a registered trademark of ExplosionAI GmbH in the United States and other countries. Python is a registered trademark of Python Software Foundation in the United States and other countries.) An embodiment also extracts additional data from the text form of a public safety alert. Some non-limiting examples of extracted entities and additional data are the type of warning (e.g., a weather event or a kidnapped child), an attribute of an entity such as characteristics included in a description of a person, a vehicle type, a location, and a time

An embodiment selects a sensor usable to collect sensor data that could be used to detect an extracted entity and communicate collected sensor data to the embodiment. Sensors that communicate collected sensor data, for example over a communications network such as the Internet, are presently available. For example, if an extracted entity is a person, vehicle, or visual weather phenomenon, an embodiment might select a camera. Some non-limiting examples of cameras usable to collect sensor data that could be used to detect an extracted entity are home cameras, camera affixed to streetlight or traffic light poles, a camera mounted on an autonomous vehicle, and a camera installed in a user's mobile device. As another example, an embodiment might select a wind sensor, weather radar sensor, or water flow sensor to detect a tornado, severe thunderstorm, flood, or other weather phenomenon. In addition, an embodiment selects only a sensor the embodiment has permission to use (e.g., the camera installed in a user's mobile device, selected only if the user opts-in to use of the camera by the embodiment). Note that a selected sensor need not be installed in the same device as a device in which an embodiment executes. Thus, using one or more of the extracted entities, an embodiment generates one or more monitoring rules. Each monitoring rule includes an instruction to at least one selected sensor to collect sensor data. One embodiment combines instructions to multiple sensors in one monitoring rule, while another embodiment uses multiple monitoring rules, each directed at a particular sensor.

The generated monitoring rule also includes a time-based validity period, i.e., a time period during which monitoring under the generated monitoring is performed. An embodiment sets the time-based validity period based on data extracted from the alert. If a time-based validity period was included in the alert, an embodiment uses that time-based validity period. For example, a tornado warning might have a validity of one hour. If a validity period was not included in the alert, an embodiment uses a default validity period appropriate to the type of warning included in and extracted from the alert (e.g., two hours for a severe thunderstorm, or two days for a kidnapped child).

The generated monitoring rule also includes a location-based validity, i.e., a set of locations or an area within which monitoring under the generated monitoring is performed. An embodiment sets the location-based validity based on data extracted from the alert. If a location-based validity was included in the alert, an embodiment uses that validity. For example, a tornado warning might have a validity within the localities specified in the warning. If a location-based validity period was not included in the alert, an embodiment uses a default validity period appropriate to the type of warning included in and extracted from the alert (e.g., a city or state for a kidnapped child).

An embodiment selects a sensor data analysis model that is appropriate to the selected sensor. Some non-limiting examples of presently available sensor data analysis models use image or video object recognition algorithms (such as R-CNN, Faster R-CNN, SSD, YOLO, and RetinaNet) and libraries (such as OpenCV and scikit-image). One embodiment selects only a sensor for which the embodiment already has access to a usable sensor data analysis model. Another embodiment determines whether a usable sensor data analysis model is already installed in the embodiment, and if not installs a usable sensor data analysis model obtained from a model repository (i.e., a presently available repository of sensor data analysis models, typically usable for payment of a license fee or purchase price), or alerts a user to provide access to a usable sensor data analysis model.

An embodiment collects sensor data according to the monitoring rule, and uses a selected sensor data analysis model to detect a presence of the first entity within sensor data collected according to the monitoring rule. Sensor data analysis models, such as models trained to detect people, objects such as vehicles or their license plates, or weather phenomena within image data, are presently available. Sensor data analysis models are also presently available to detect an occurrence of a phenomenon within non-visual data, or a combination of image and non-visual data. For example, one sensor data analysis model might combine data from a wind sensor, lightning detector, and rainfall detector to detect a thunderstorm.

An embodiment generates, using a text generation model, a text report corresponding to the public safety alert. The text report reports the presence of an entity extracted from the public safety alert. Optionally, the text report includes additional detail, such as a time or location at which the presence of the first entity was detected, sensor data (e.g., an image) in which the presence of the first entity was detected, and the like. One embodiment includes sensor data in the report only if a user approves the inclusion. An embodiment provides the text report to an alert originator or another entity requesting responses to a public safety alert, such as local emergency management officials or police. Some embodiments generate and provides the text report only if a presence of the first entity was detected with a confidence level higher than a threshold level, if more than a threshold number of characteristics specified in the public safety alert were each detected with a confidence level higher than a threshold level, or if a user responsible for an embodiment permitted providing the text report grants permission.

An embodiment aggregates text reports received from another embodiment or another source, by using a presently available natural language processing technique to extract one or more keywords and entities from text reports, forming clusters of reports based on an alert or alert type, report location, or report time, and eliminating or underweighting anomalous reports (i.e., reports that are outside any cluster or reports in a cluster that includes less than a threshold number of reports).

An embodiment uses one or more text reports to update an original public safety alert with new detail for improved detection. For example, the information reported back could contain a license plate number which was not available in the original alert, and if the likelihood of validity of this new piece of information is sufficiently high, an embodiment might update the original alert with the license plate number.

Once a time-based validity period of a particular monitoring rule expires, an embodiment stops monitoring sensor data according to the monitoring rule. Once a time-based validity period of a monitoring rule expires, one embodiment also deletes the monitoring rule.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

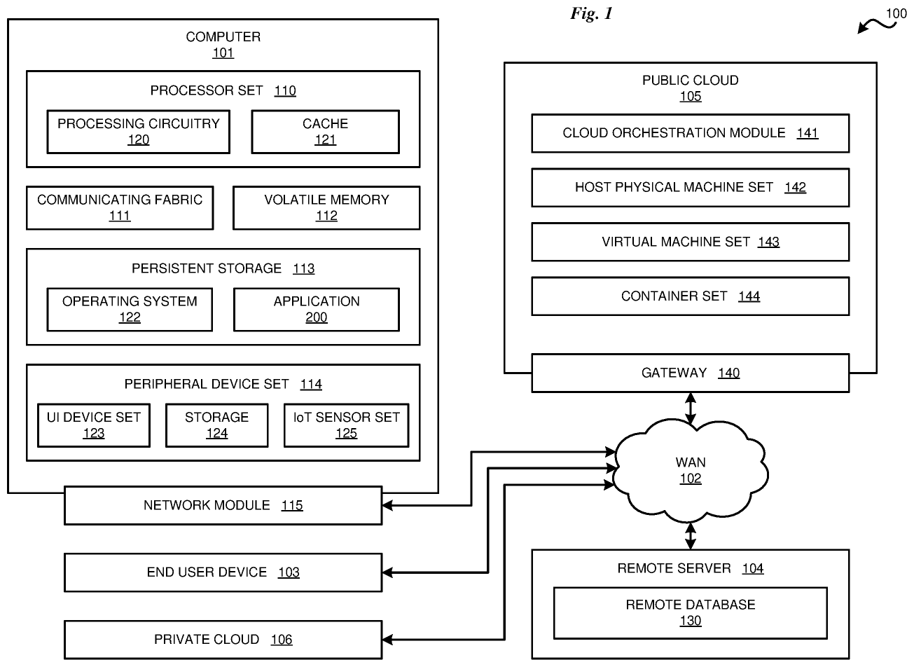

With reference to FIG. 1, this figure depicts a block diagram of a computing environment 100. Computing environment 100 contains an example of an environment for the execution of at least some of the computer code involved in performing the inventive methods, such as application 200 implementing monitoring and detection in response to a public safety alert. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

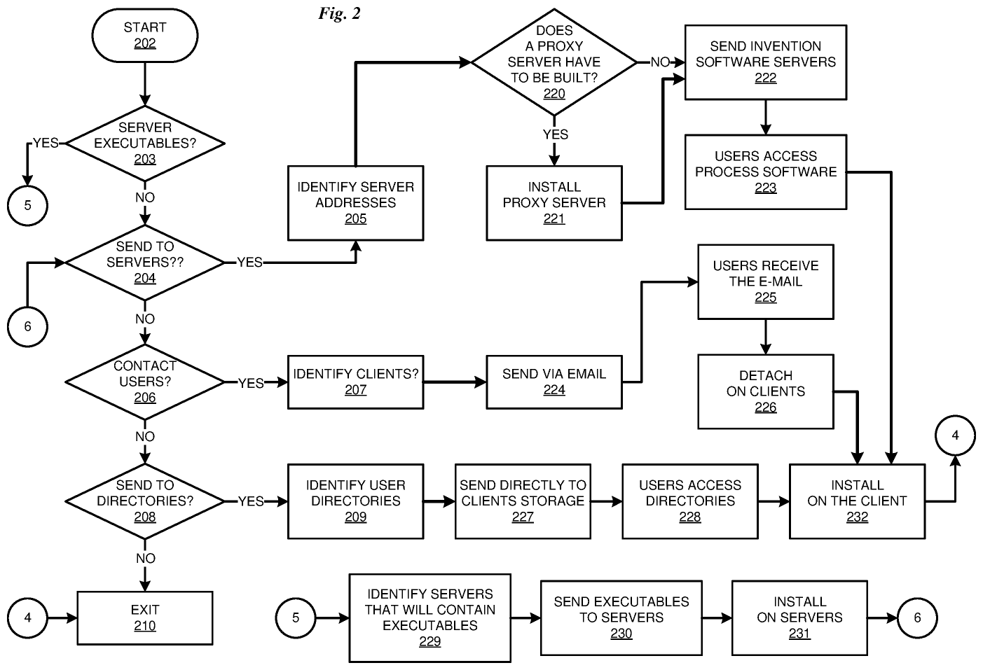

With reference to FIG. 2, this figure depicts a flowchart of an example process for loading of process software in accordance with an illustrative embodiment. The flowchart can be executed by a device such as computer 101, end user device 103, remote server 104, or a device in private cloud 106 or public cloud 105 in FIG. 1.

While it is understood that the process software implementing monitoring and detection in response to a public safety alert may be deployed by manually loading it directly in the client, server, and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Step 202 begins the deployment of the process software. An initial step is to determine if there are any programs that will reside on a server or servers when the process software is executed (203). If this is the case, then the servers that will contain the executables are identified (229). The process software for the server or servers is transferred directly to the servers' storage via FTP or some other protocol or by copying though the use of a shared file system (230). The process software is then installed on the servers (231).

Next, a determination is made on whether the process software is to be deployed by having users access the process software on a server or servers (204). If the users are to access the process software on servers, then the server addresses that will store the process software are identified (205).

A determination is made if a proxy server is to be built (220) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (221). The process software is sent to the (one or more) servers either via a protocol such as FTP, or it is copied directly from the source files to the server files via file sharing (222). Another embodiment involves sending a transaction to the (one or more) servers that contained the process software, and have the server process the transaction and then receive and copy the process software to the server's file system. Once the process software is stored at the servers, the users via their client computers then access the process software on the servers and copy to their client computers file systems (223). Another embodiment is to have the servers automatically copy the process software to each client and then run the installation program for the process software at each client computer. The user executes the program that installs the process software on his client computer (232) and then exits the process (210).

In step 206 a determination is made whether the process software is to be deployed by sending the process software to users via e-mail. The set of users where the process software will be deployed are identified together with the addresses of the user client computers (207). The process software is sent via e-mail to each of the users' client computers (224). The users then receive the e-mail (225) and then detach the process software from the e-mail to a directory on their client computers (226). The user executes the program that installs the process software on his client computer (232) and then exits the process (210).

Lastly, a determination is made on whether the process software will be sent directly to user directories on their client computers (208). If so, the user directories are identified (209). The process software is transferred directly to the user's client computer directory (227). This can be done in several ways such as, but not limited to, sharing the file system directories and then copying from the sender's file system to the recipient user's file system or, alternatively, using a transfer protocol such as File Transfer Protocol (FTP). The users access the directories on their client file systems in preparation for installing the process software (228). The user executes the program that installs the process software on his client computer (232) and then exits the process (210).

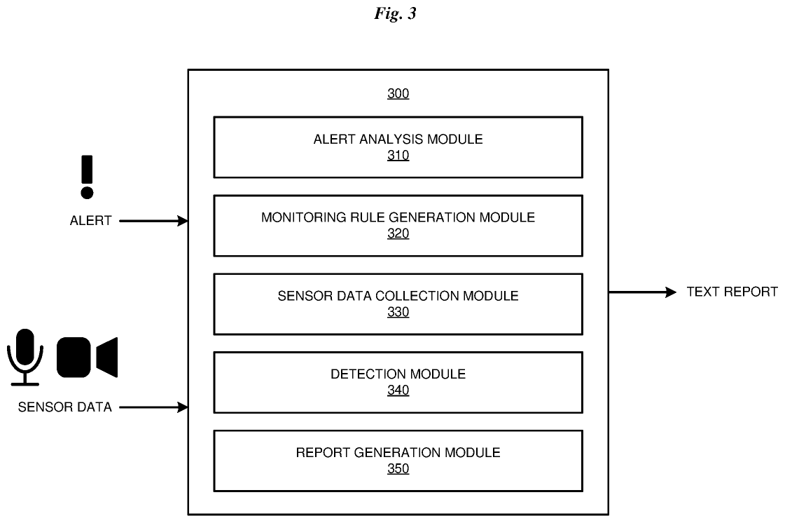

With reference to FIG. 3, this figure depicts a block diagram of an example configuration for monitoring and detection in response to a public safety alert in accordance with an illustrative embodiment. Application 300 is the same as application 200 in FIG. 1.

In the illustrated embodiment, application 300 receives a public safety alert. One implementation of application 300 receives a public safety alert in text form. Another implementation of application 300 receives a public safety alert in a non-textual form (e.g., audio, still image, or video), or a combination of a non-textual form and text, and uses a presently available technique to convert a non-text portion of the alert into text form for further analysis. For example, techniques are presently available to convert spoken audio to text, to extract text from video or a still image, and to generate text describing a portion of video or a still image.

Alert analysis module 310 uses a presently available natural language processing model to extract one or more entities from the text form of a public safety alert. Some examples of presently available natural language processing models are implemented using the Natural Language Toolkit (NLTK) or Spacy libraries, both implemented in the Python computer language. Module 310 also extracts additional data from the text form of a public safety alert. Some non-limiting examples of extracted entities and additional data are the type of warning (e.g., a weather event or a kidnapped child), an attribute of an entity such as characteristics included in a description of a person, a vehicle type, a location, and a time

Monitoring rule generation module 320 selects a sensor usable to collect sensor data that could be used to detect an extracted entity and communicate collected sensor data to the embodiment. Sensors that communicate collected sensor data, for example over a communications network such as the Internet, are presently available. For example, if an extracted entity is a person, vehicle, or visual weather phenomenon, module 320 might select a camera. Some non-limiting examples of cameras usable to collect sensor data that could be used to detect an extracted entity are home cameras, camera affixed to streetlight or traffic light poles, a camera mounted on an autonomous vehicle, and a camera installed in a user's mobile device. As another example, module 320 might select a wind sensor, weather radar sensor, or water flow sensor to detect a tornado, severe thunderstorm, flood, or other weather phenomenon. In addition, module 320 selects only a sensor the embodiment has permission to use (e.g., the camera installed in a user's mobile device, selected only if the user opts-in to use of the camera). Note that a selected sensor need not be installed in the same device as a device in which application 300 executes. Thus, using one or more of the extracted entities, module 320 generates one or more monitoring rules. Each monitoring rule includes an instruction to at least one selected sensor to collect sensor data. One implementation of module 320 combines instructions to multiple sensors in one monitoring rule, while another implementation of module 320 uses multiple monitoring rules, each directed at a particular sensor.

The generated monitoring rule also includes a time-based validity period, i.e., a time period during which monitoring under the generated monitoring is performed. Module 320 sets the time-based validity period based on data extracted from the alert. If a time-based validity period was included in the alert, module 320 uses that time-based validity period. For example, a tornado warning might have a validity of one hour. If a validity period was not included in the alert, module 320 uses a default validity period appropriate to the type of warning included in and extracted from the alert (e.g., two hours for a severe thunderstorm, or two days for a kidnapped child).

The generated monitoring rule also includes a location-based validity, i.e., a set of locations or an area within which monitoring under the generated monitoring is performed. Module 320 sets the location-based validity based on data extracted from the alert. If a location-based validity was included in the alert, module 320 uses that validity. For example, a tornado warning might have a validity within the localities specified in the warning. If a location-based validity period was not included in the alert, module 320 uses a default validity period appropriate to the type of warning included in and extracted from the alert (e.g., a city or state for a kidnapped child).

Detection module 340 selects a sensor data analysis model that is appropriate to the selected sensor. Some non-limiting examples of presently available sensor data analysis models use image or video object recognition algorithms (such as R-CNN, Faster R-CNN, SSD, YOLO, and RetinaNet) and libraries (such as OpenCV and scikit-image). One implementation of module 340 selects only a sensor for which the embodiment already has access to a usable sensor data analysis model. Another implementation of module 340 determines whether a usable sensor data analysis model is already installed in the embodiment, and if not installs a usable sensor data analysis model obtained from a model repository (i.e., a presently available repository of sensor data analysis models, typically usable for payment of a license fee or purchase price), or alerts a user to provide access to a usable sensor data analysis model.

Sensor data collection module 330 collects sensor data according to the monitoring rule, and detection module 340 uses a selected sensor data analysis model to detect a presence of the first entity within sensor data collected according to the monitoring rule. Sensor data analysis models, such as models trained to detect people, objects such as vehicles or their license plates, or weather phenomena within image data, are presently available. Sensor data analysis models are also presently available to detect an occurrence of a phenomenon within non-visual data, or a combination of image and non-visual data. For example, one sensor data analysis model might combine data from a wind sensor, lightning detector, and rainfall detector to detect a thunderstorm.

Report generation module 350 generates, using a text generation model, a text report corresponding to the public safety alert. The text report reports the presence of an entity extracted from the public safety alert. Optionally, the text report includes additional detail, such as a time or location at which the presence of the first entity was detected, sensor data (e.g., an image) in which the presence of the first entity was detected, and the like. One implementation of module 350 includes sensor data in the report only if a user approves the inclusion. Module 350 provides the text report to an alert originator or another entity requesting responses to a public safety alert, such as local emergency management officials or police. Some implementations of module 350 generate and provides the text report only if a presence of the first entity was detected with a confidence level higher than a threshold level, if more than a threshold number of characteristics specified in the public safety alert were each detected with a confidence level higher than a threshold level, or if a user responsible for an embodiment permitted providing the text report grants permission.

Module 350 aggregates text reports received from another instance of module 350 or another source, by using a presently available natural language processing technique to extract one or more keywords and entities from text reports, forming clusters of reports based on an alert or alert type, report location, or report time, and eliminating or underweighting anomalous reports (i.e., reports that are outside any cluster or reports in a cluster that includes less than a threshold number of reports).

Module 350 uses one or more text reports to update an original public safety alert with new detail for improved detection. For example, the information reported back could contain a license plate number which was not available in the original alert, and if the likelihood of validity of this new piece of information is sufficiently high, module 350 might update the original alert with the license plate number.

Once a time-based validity period of a particular monitoring rule expires, application 300 stops monitoring sensor data according to the monitoring rule. Once a time-based validity period of a monitoring rule expires, one implementation of application 300 also deletes the monitoring rule.

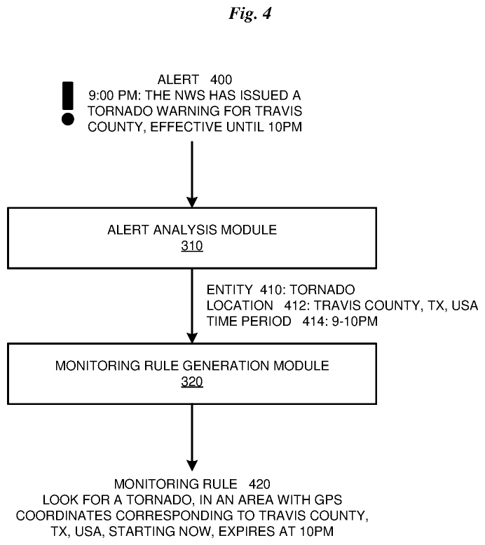

With reference to FIG. 4, this figure depicts an example of monitoring and detection in response to a public safety alert in accordance with an illustrative embodiment. The example can be executed using application 300 in FIG. 3. Alert analysis module 310 and monitoring rule generation module 320 are the same as alert analysis module 310 and monitoring rule generation module 320 in FIG. 3.

As depicted, alert analysis module 310 receives public safety alert 400, a tornado warning, in text form. Alert analysis module 310 uses a presently available natural language processing model to extract entity 410 (a tornado), location 412, and time period 414 from alert 400.

Monitoring rule generation module 320, using entity 410, generates monitoring rule 420, including an instruction to a selected sensor (a camera) to collect sensor data. Monitoring rule 420 also includes a time-based validity period and a location-based validity.

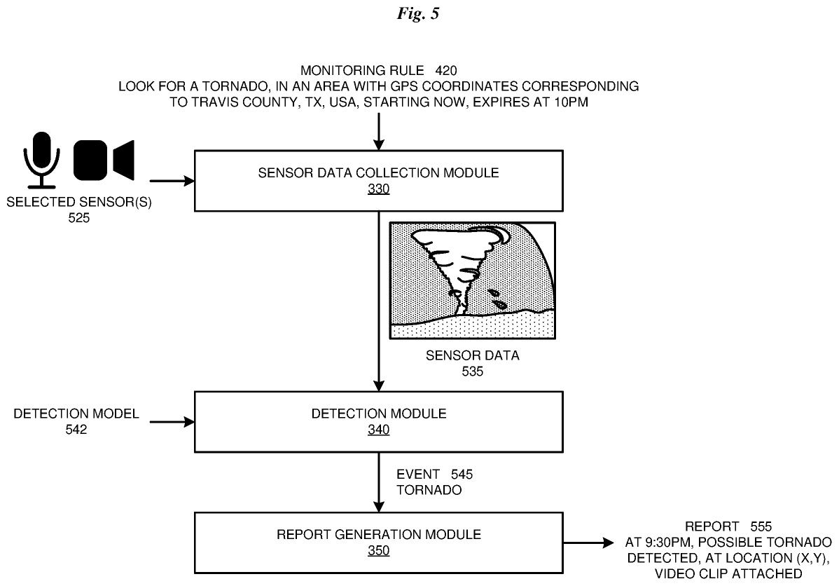

With reference to FIG. 5, this figure depicts a continued example of monitoring and detection in response to a public safety alert in accordance with an illustrative embodiment. Sensor data collection module 330, detection module 340, and report generation module 350 are the same as sensor data collection module 330, detection module 340, and report generation module 350 in FIG. 3. Monitoring rule 420 is the same as monitoring rule 420 in FIG. 4.

Sensor data collection module 330 collects sensor data from selected sensor(s) 525 according to monitoring rule 420, resulting in sensor data 535 (an image of a tornado). Detection module 340 uses detection model 542 to detect event 545 (a tornado) within sensor data 535. As a result, report generation module 350 generates report 555, a text report corresponding to the public safety alert 400 in FIG. 4.

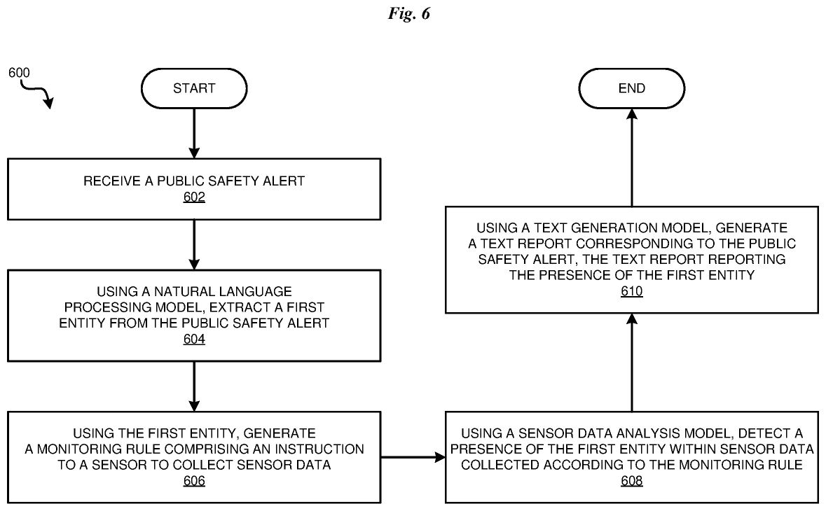

With reference to FIG. 6, this figure depicts a flowchart of an example process for monitoring and detection in response to a public safety alert in accordance with an illustrative embodiment. Process 600 can be implemented in application 200 in FIG. 3.

In the illustrated embodiment, at block 602, the process receives a public safety alert. At block 604, the process, using a natural language processing model, extracts a first entity from the public safety alert. At block 606, the process, using the first entity, generates a monitoring rule comprising an instruction to a sensor to collect sensor data. At block 608, the process, using a sensor data analysis model, detects a presence of the first entity within sensor data collected according to the monitoring rule. At block 610, the process, using a text generation model, generates a text report corresponding to the public safety alert, the text report reporting the presence of the first entity. Then the process ends.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
extracting, using a natural language processing model, a first entity from a public safety alert;
generating, using the first entity, a monitoring rule, the monitoring rule comprising an instruction to a sensor to collect sensor data; and
detecting, using a sensor data analysis model, a presence of the first entity within sensor data collected according to the monitoring rule.

2. The computer-implemented method of claim 1, wherein the monitoring rule comprises a time-based validity.

3. The computer-implemented method of claim 1, wherein the monitoring rule comprises a location-based validity.

4. The computer-implemented method of claim 1, wherein the sensor data analysis model is selected according to the sensor.

5. The computer-implemented method of claim 4, further comprising:
installing, responsive to determining that the sensor data analysis model is not installed, the sensor data analysis model, the sensor data analysis model obtained from a model repository.

6. The computer-implemented method of claim 1, further comprising:
generating, using a text generation model, a text report corresponding to the public safety alert, the text report reporting the presence of the first entity.

7. A computer program product comprising one or more computer readable storage media, and program instructions collectively stored on the one or more computer readable storage media, the program instructions executable by a processor to cause the processor to perform operations comprising:
extracting, using a natural language processing model, a first entity from a public safety alert;
generating, using the first entity, a monitoring rule, the monitoring rule comprising an instruction to a sensor to collect sensor data; and
detecting, using a sensor data analysis model, a presence of the first entity within sensor data collected according to the monitoring rule.

8. The computer program product of claim 7, wherein the stored program instructions are stored in a computer readable storage device in a data processing system, and wherein the stored program instructions are transferred over a network from a remote data processing system.

9. The computer program product of claim 7, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

10. The computer program product of claim 7, wherein the monitoring rule comprises a time-based validity.

11. The computer program product of claim 7, wherein the monitoring rule comprises a location-based validity.

12. The computer program product of claim 7, wherein the sensor data analysis model is selected according to the sensor.

13. The computer program product of claim 12, further comprising:
installing, responsive to determining that the sensor data analysis model is not installed, the sensor data analysis model, the sensor data analysis model obtained from a model repository.

14. The computer program product of claim 7, further comprising:
generating, using a text generation model, a text report corresponding to the public safety alert, the text report reporting the presence of the first entity.

15. A computer system comprising a processor and one or more computer readable storage media, and program instructions collectively stored on the one or more computer readable storage media, the program instructions executable by the processor to cause the processor to perform operations comprising:
extracting, using a natural language processing model, a first entity from a public safety alert;
generating, using the first entity, a monitoring rule, the monitoring rule comprising an instruction to a sensor to collect sensor data; and
detecting, using a sensor data analysis model, a presence of the first entity within sensor data collected according to the monitoring rule.

16. The computer system of claim 15, wherein the monitoring rule comprises a time-based validity.

17. The computer system of claim 15, wherein the monitoring rule comprises a location-based validity.

18. The computer system of claim 15, wherein the sensor data analysis model is selected according to the sensor.

19. The computer system of claim 18, further comprising:
installing, responsive to determining that the sensor data analysis model is not installed, the sensor data analysis model, the sensor data analysis model obtained from a model repository.

20. The computer system of claim 15, further comprising:
generating, using a text generation model, a text report corresponding to the public safety alert, the text report reporting the presence of the first entity.
